(19) United States
(12) Patent Application Publication
(10) Pub. No.: US 2024/0241147 A1
(43) Pub. Date: Jul. 18, 2024

(54) LABORATORY SYSTEM FOR SAMPLING REACTOR CONTENTS

(71) Applicant: TCS Patent B.V., Alkmaar (NL)

(72) Inventors: Stephan Olivier van Banning, Santpoort Noord (NL); Serge Peter Sonneborn, Heiloo (NL); David Michael Pfisterer, Groton, CT (US); Joel Michael Hawkins, Groton, CT (US)

(21) Appl. No.: 18/553,653

(22) PCT Filed: Apr. 14, 2022
(86) PCT No.: PCT/EP2022/060000

§ 371 Date: Oct. 2, 2023

(30) Foreign Application Priority Data
Apr. 14, 2021 (NL) 2027966

(51) Int. Cl. G01N 35/10; B01L 7/00; G01N 1/34; G01N 35/00

(52) U.S. Cl. CPC G01N 35/1067; B01L 7/52; G01N 1/34; G01N 35/10; G01N 2035/00366; G01N 2035/1027

(57) ABSTRACT

A laboratory system includes: at least one reactor; a sample extraction device for extracting a sample from the at least one reactor into a sampling space; a fluid supply system including a transportation fluid supply; at least one sample storage container; at least one fluid supply channel connecting the extraction device to the fluid supply system; at least one sample extraction channel connecting the extraction device to the sample storage container, where the fluid supply system is arranged to push the sample from the sampling space through the sample extraction channel to the at least one sample storage container using transportation fluid of the transportation fluid supply.

### CROSS-REFERENCE TO RELATED APPLICATIONS

This application is the National Stage of International Application No. PCT/EP2022/060000, filed Apr. 14, 2022, which claims the benefit of Netherlands Application No. 2027966, filed Apr. 14, 2021, the contents of which is incorporated by reference herein.

### FIELD OF THE INVENTION

The present invention relates to laboratory systems and sample extraction devices and methods, in particular at least partially automated laboratory systems and sample extraction devices and methods.

### BACKGROUND OF THE INVENTION

In process chemistry and crystallization analysis in particular, many reactions are often performed in research. Taking samples from such reactions is a valuable tool to provide insight in reaction processes such as crystallization and/or process chemistry. In current systems such as manual or partially automated pipetting devices, sampling is a labor intensive and complex process, leading to significant cost and possibility of human error. Furthermore, current systems often require a relatively large sample to be taken.

### OBJECT OF THE INVENTION

It is an object of the invention to provide a device and method for sampling a reactor in an efficient manner. It is a further object of the invention to provide a device and method for sampling a reactor in an accurate and/or reproducible manner. It is a further object of the invention to provide a device and method for sampling a reactor in a less labor intensive manner.

### SUMMARY OF THE INVENTION

In order to achieve at least one of the objects, in a first aspect of the invention a laboratory system is provided, comprising:
at least one reactor,
a sample extraction device for extracting a sample from the at least one reactor into a sampling space,
a fluid supply system comprising a transportation fluid supply,
at least one sample storage container,
at least one fluid supply channel connecting the extraction device to the fluid supply system,
at least one sample extraction channel connecting the extraction device to the sample storage container,
wherein the fluid supply system is arranged to push the sample from the sampling space through the sample extraction channel to the at least one sample storage container using transportation fluid of the transportation fluid supply.

The system according to the invention allows sampling a reactor in an efficient manner, while minimizing the chance of operator error and providing a high repeatability accuracy.

In an embodiment, the laboratory system comprises:
multiple sample storage containers,
a container selection system to associate the at least one sample extraction channel with one of the multiple sample storage containers.

In an embodiment:
the laboratory system comprises multiple reactors,
the sample extraction device cooperates with each of the multiple reactors via a downstream reactor selection system for extracting a sample from a selected reactor into the sampling space,
the at least one fluid supply channel connects the fluid supply system to the sample extraction device, and
the at least one sample extraction channel connects the sample extraction device to the at least one sample storage container.

In an embodiment, the laboratory system comprises N reactors, wherein the downstream reactor selection system comprises a downstream N-way valve configured for bringing the sample extraction device in fluid communication with one of the N reactors. The downstream N-way valve comprises one inlet and N outlets, yielding a total of N+1 fluid connections.

In an embodiment:
the laboratory system comprises multiple reactors and multiple sample extraction devices,
each sample extraction device has a sampling space and each sample extraction device cooperates with one of the multiple reactors for extracting a sample from the at least one reactor into the respective sampling space,
the at least one fluid supply channel connects the fluid supply system to each sample extraction device, and
the at least one sample extraction channel connects each sample extraction device to the at least one sample storage container.

In an embodiment, the laboratory system comprises N reactors, the laboratory system comprising an upstream reactor selection system configured for bringing the sample extraction device of one of the N reactors in fluid communication with the fluid supply system. The upstream N-way valve comprises one inlet and N outlets, yielding a total of N+1 fluid connections.

In an embodiment, the upstream reactor selection system comprises an upstream N-way valve arranged in the fluid supply channel.

In an embodiment, the at least one reactor is a thermal cycle reactor.

In an embodiment, the fluid supply system comprises a quench fluid supply.

In an embodiment, the fluid supply system is arranged to push quench fluid from the quench fluid supply through the fluid supply channel, the sampling space and/or the sample extraction channel using transportation fluid of the transportation fluid supply.

In an embodiment, the fluid supply system comprises a dilution fluid supply.

In an embodiment, the fluid supply system is arranged to push dilution fluid from the dilution fluid supply through the fluid supply channel, the sampling space and/or the sample extraction channel using transportation fluid of the transportation fluid supply.

In an embodiment, the fluid supply system comprises a rinsing fluid supply.

In an embodiment, the fluid supply system is arranged to push rinsing fluid from the rinsing fluid supply through the fluid supply channel, the sampling space and/or the sample extraction channel using transportation fluid of the transportation fluid supply.

In an embodiment, the sample extraction device comprises:
a sample channel configured to extend into a reactor volume of the reactor, the sample channel comprising a sample channel entrance configured to be arranged below a liquid level of a reaction liquid in the reactor volume of the reactor,
a sampling valve arranged in the sample channel and comprising the sampling space, wherein the sampling valve is movable between a sampling position and a transportation position,
a secondary fluid channel configured to extend into a reactor volume of the reactor, the secondary fluid channel comprising a secondary fluid channel entrance,
wherein, in the sampling position of the sampling valve, the sampling space is in fluid communication with the sample channel and wherein, in the transportation position of the sampling valve, the sampling space is in fluid communication with the at least one fluid supply channel and the at least one sample extraction channel.

In an embodiment, the secondary fluid channel is connectable to the transportation fluid supply.

In a second aspect, the invention provides a method of sampling using a laboratory system according to any of the preceding embodiments, the method comprising the steps of:
extracting a sample from the reactor into the sampling space,
transporting the sample to the sample storage container via the sample extraction channel by supplying the transportation fluid to the sampling space via the fluid supply channel.

In an embodiment, the method comprises the step of supplying a quench fluid from the quench fluid supply to the sample.

In an embodiment, the quench fluid is supplied to the sample via the fluid supply channel.

In an embodiment, the quench fluid is supplied to the sample in the sample storage container.

In an embodiment, the step of supplying the quench fluid comprises pushing the quench fluid through the fluid supply channel, the sampling space and/or the sample extraction channel using transportation fluid of the transportation fluid supply.

In an embodiment, the method comprises the step of supplying a dilution fluid to the sample.

In an embodiment, the dilution fluid is supplied to the sample via the fluid supply channel.

In an embodiment, the dilution fluid is supplied to the sample in the sample storage container.

In an embodiment, the step of supplying the dilution fluid comprises pushing the dilution fluid through the fluid supply channel, the sampling space and/or the sample extraction channel using transportation fluid of the transportation fluid supply.

In an embodiment, the method comprises a rinsing step of rinsing the fluid supply channel by supplying a rinsing fluid from a rinsing fluid supply to the fluid supply channel and depositing the rinsing fluid in a waste container.

In an embodiment, the rinsing step further comprises rinsing the sampling space and/or the at least one sample extraction channel by supplying the rinsing fluid to the sampling space and/or the at least one sample extraction channel from the fluid supply channel.

In an embodiment, the step of supplying the rinsing fluid comprises pushing the rinsing fluid through the fluid supply channel, the sampling space and/or the sample extraction channel using transportation fluid of the transportation fluid supply.

In an embodiment, the sample is extracted from the reactor into the sampling space by injecting the transportation fluid into the reactor volume via the secondary fluid channel.

In an embodiment, the method comprises the step of registering a sample trigger to initiate sampling. The sample trigger may comprise a timestamp, a temperature measurement falling within or outside a certain range, a measurement of a reactor process parameter such as a crystallization parameter, a transmissivity measurement, a user input, or any other trigger. Measurements in order to determine the sample trigger may be performed by an analytics system comprising a Raman spectrometer and/or a camera monitoring the reactor. Timestamped data from the analytics system can then be compared with timestamped sample analysis data, for example data acquired by high-performance liquid chromatography or any other offline analysis of the samples, in order to achieve a comprehensive dataset of the reactor processes.

In a third aspect, the invention provides a sample extraction device configured for extracting a sample from a reactor, the sample extraction device comprising:
a sample extraction outlet,
a sample channel configured to extend into a reactor volume of the reactor, the sample channel comprising a sample channel entrance configured to be arranged below a liquid level of a reaction liquid in the reactor volume of the reactor,
a sampling valve arranged in the sample channel,
a secondary fluid channel configured to extend into a reactor volume of the reactor, the secondary fluid channel comprising a secondary fluid channel entrance,
wherein:
the sampling valve comprises a sampling space with a cavity volume,
the sampling valve is movable between a sampling position and a transportation position,
wherein the sampling space is in fluid communication with the sample channel in the sampling position of the sampling valve and wherein the sampling space is in fluid communication with the sample extraction outlet in the transportation position of the sampling valve.

The sample extraction device according to the invention allows extraction of a sample from a reactor in an efficient manner, while minimizing the chance of operator error and providing a high repeatability accuracy.

In a fourth aspect, the invention provides a method of sampling a reaction liquid from a reactor using a sample extraction device according to the previous embodiment, the method comprising the steps of:
arranging the sampling valve in the sampling position,
filling the sampling space with a sampling volume of reaction liquid via the sample channel, the sampling volume being equal to the cavity volume,
subsequently arranging the sampling valve in the transportation position,
transporting the sampling volume of reaction liquid from the sampling space through the sample extraction outlet to a suitable destination.

In an embodiment, the step of filling the sampling space is performed by applying a pressure differential between the reactor volume and the sampling space.

In an embodiment, the pressure differential is achieved by introducing fluid into the reactor volume via the secondary fluid channel at a pressure above the pressure in the sampling space, thereby forcing the reaction liquid into the sampling space through the sample channel.

These and other aspects of the invention will be more readily appreciated as the same becomes better understood by reference to the following detailed description and considered in connection with the accompanying drawings in which like reference symbols designate like parts. It will be clear to the skilled person that the features of any of the above embodiments can be combined.

### BRIEF DESCRIPTION OF THE FIGURES

Embodiments of the laboratory system according to the invention and the extraction device according to the invention and the method according to the invention will be described by way of example only, with reference to the accompanying schematic drawings in which corresponding reference symbols indicate corresponding parts, and in which:

FIG. 1 shows a schematic depiction of a laboratory system according to the invention.

FIG. 2 shows a schematic depiction of a sample extraction device according to the invention.

FIG. 3 shows a laboratory system according to the invention.

### DETAILED DESCRIPTION OF THE INVENTION

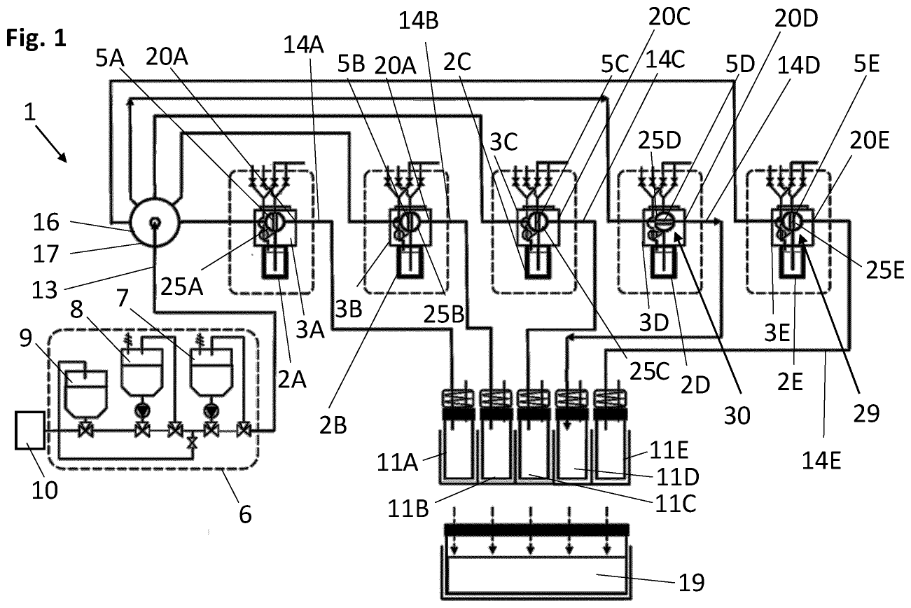

FIG. 1 shows a schematic depiction of a laboratory system 1 according to the invention. The laboratory system 1 comprises five reactors 2A, 2B, 2C, 2D, 2E, for example thermal cycle reactors, each being associated with a respective sample extraction device 3A, 3B, 3C, 3D, 3E for extracting a sample from the reactor 2A, 2B, 2C, 2D, 2E. The laboratory system 1 further comprises a fluid supply system 6 comprising a transportation fluid supply 10 for supplying a transportation fluid. Said transportation fluid comprises nitrogen gas or any other suitable fluid, for example a substantially inert fluid such as a noble gas. The fluid supply system 6 further comprises a quench fluid supply 7, a dilution fluid supply 8 and a rinsing fluid supply 9. The fluid supply system 6 is connected to the extraction devices 3A, 3B, 3C, 3D, 3E via a fluid supply channel 13, through which fluid from the fluid supply system 6, such as transportation fluid from the transportation fluid supply 10, is transported to the extraction devices 3A, 3B, 3C, 3D, 3E. Five sample storage containers 11A, 11B, 11C, 11D, 11E are provided for storing samples extracted from the reactors 2A, 2B, 2C, 2D, 2E. The storage containers 11A, 11B, 11C, 11D, 11E are connected to the reactors 2A, 2B, 2C, 2D, 2E via sample extraction channels 14A, 14B, 14C, 14D, 14E.

When a sample is taken from one of the reactors 2A, 2B, 2C, 2D, 2E, a sample is first extracted from the reactor 2A, 2B, 2C, 2D, 2E into the sampling space 5A, 5B, 5C, 5D, 5E. The fluid supply system 6 then pushes the sample from the sampling space 5A, 5B, 5C, 5D, 5E through the sample extraction channel 14A, 14B, 14C, 14D, 14E to the sample storage container 11A, 11B, 11C, 11D, 11E using transportation fluid of the transportation fluid supply 10.

The laboratory system 1 may further comprise multiple storage containers 11A, 11B, 11C, 11D, 11E associated with each of the reactors 2A, 2B, 2C, 2D, 2E, such that multiple samples may be taken from each reactor 2A, 2B, 2C, 2D, 2E. A container selection system (not imaged) is provided to associate the sample extraction channel 14A, 14B, 14C, 14D, 14E with one of the multiple sample storage containers 11A, 11B, 11C, 11D, 11E, such that each sample may be stored in a separate sample storage container 11A, 11B, 11C, 11D, 11E.

Seeing that the laboratory system 1 comprises multiple reactors 2A, 2B, 2C, 2D, 2E, a reactor selection system is provided to select a reactor from which a sample is to be taken. Two variants of such a reactor selection system are disclosed, being an upstream reactor selection system 16 as shown in FIG. 1 and a downstream reactor selection system (not imaged).

In the imaged embodiment, each reactor 2A, 2B, 2C, 2D, 2E is associated with a respective sample extraction device 3A, 3B, 3C, 3D, 3E having a respective sampling space 5A, 5B, 5C, 5D, 5E. The sample extraction devices 3A, 3B, 3C, 3D, 3E are configured for extracting a sample from the reactor 2A, 2B, 2C, 2D, 2E into the sampling space 5A, 5B, 5C, 5D, 5E. Each sample extraction device 3A, 3B, 3C, 3D, 3E is connected to a respective sample storage container 11A, 11B, 11C, 11D, 11E by the sample extraction channel 14A, 14B, 14C, 14D, 14E. The fluid supply channel 13 connects the fluid supply system 6 to each sample extraction device 3A, 3B, 3C, 3D, 3E. An upstream reactor selection system 16 comprising a 5-way valve 17 arranged in the fluid supply channel 13 is provided to bring a chosen sample extraction device 3A, 3B, 3C, 3D, 3E of one of the reactors 2A, 2B, 2C, 2D, 2E in fluid communication with the fluid supply system 6. In FIG. 1, the sample extraction device 3D of the fourth reactor 2D is shown in fluid communication with the fluid supply system 6, while the sample extraction devices 3A, 3B, 3C, 3E of the first, second, third and fifth reactors 2A, 2B, 2C, 2E are not in fluid communication with the fluid supply system 6. In an alternative embodiment, each sample extraction device 3A, 3B, 3C, 3D, 3E may comprise a valve for regulating fluid communication with the fluid supply system 6, such that the 5-way valve 17 is not necessary.

Alternatively, a single sample extraction device 3 connected to each of the reactors 2A, 2B, 2C, 2D, 2E via a downstream reactor selection system may be used. In such an embodiment, the reactor 2A, 2B, 2C, 2D, 2E, from which a sample is to be taken by the single sample extraction device 3 is determined by the downstream reactor selection system. Such a downstream reactor selection system may also comprise a 5-way valve for bringing the sample extraction device 3 in fluid communication with one of the reactors 2A, 2B, 2C, 2D, 2E.

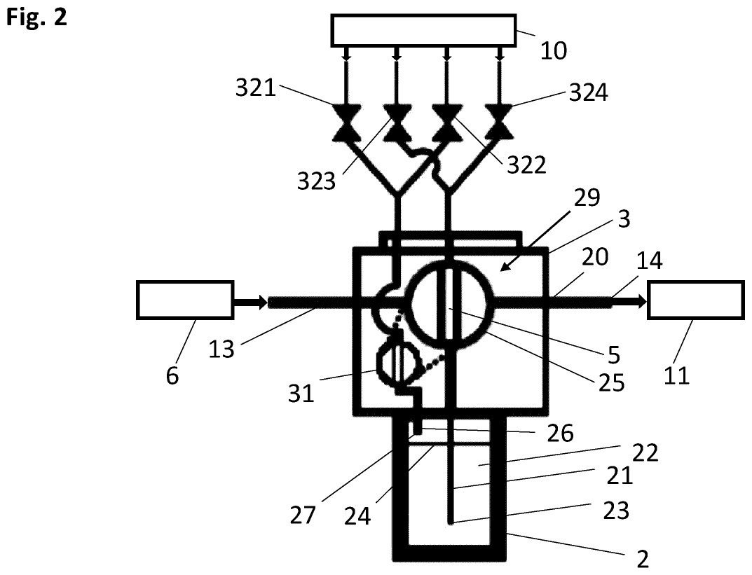

FIG. 2 shows a schematic depiction of a sample extraction device 3 in more detail. The sample extraction device 3 comprises a sample channel 21 extending into the reactor volume 22 of the reactor 2 with a sample channel entrance 23 arranged below a liquid level 24 of a reaction liquid in the reactor volume 22 of the reactor 2. A sampling valve 25 is provided in the sampling channel 21 which is movable, for example rotatable, between a sampling position 29 and a transportation position 30. The sampling valve 25 is arranged above the liquid level 24 of the reaction liquid. In the sampling position 29, a sampling space 5 with a cavity volume provided in the sampling valve 25 is in fluid communication with the sample channel 21 and in the transportation position 30, the sampling space 5 is in fluid communication with the fluid supply channel 13 and, via a sample extraction outlet 20, with the sample extraction channel 14. The sample extraction device 3 further comprises a secondary fluid channel 26 extending into the reactor volume 22, the secondary fluid channel 26 comprising a secondary fluid channel entrance 27 arranged in the reactor volume 22. The secondary fluid channel 26 is connectable to the transportation fluid supply 10.

Sampling may be initiated by registration of a sample trigger such as a time measurement, a temperature measurement, a measurement of a reactor process parameter such as a crystallization parameter, a transmissivity measurement or any other measurement reaching a certain threshold value, or a user input, or any other trigger. Taking a sample using the laboratory system 1 comprises first selecting the reactor 2A, 2B, 2C, 2D, 2E using the reactor selection system 16. A sample is then extracted from the reactor 2A, 2B, 2C, 2D, 2E into the sampling space 5A, 5B, 5C, 5D, 5E of the associated sample extraction device 3A, 3B, 3C, 3D, 3E. The sample is subsequently transported to the sample storage container 11A, 11B, 11C, 11D, 11E via the sample extraction channel 14A, 14B, 14C, 14D, 14E by supplying the transportation fluid to the sampling space 5A, 5B, 5C, 5D, 5E via the fluid supply channel 13. A sample can thus be taken under reactor conditions so as to minimize disturbance to reactor processes occurring inside the reactor, such as chemical processes and crystallization processes. Referring back to FIG. 1, the sampling valve 25D of the sample extraction device 3D of the fourth reactor 2D is arranged in the transportation position 30 such that the sampling space 5D is in fluid communication with the fluid supply channel 13 and, via a sample extraction outlet 20D, with the sample extraction channel 14D. The sampling valves 25A, 25B, 25C, 25E of the sample extraction devices 3A, 3B, 3C, 3E of the first, second, third and fifth reactors 2A, 2B, 2C, 2E are arranged in the sampling position 29 such that the respective sampling spaces 5A, 5B, 5C, 5E are in fluid communication with the fluid supply channel 13 and, via the respective sample extraction outlets 20A, 20B, 20C 20E, with the respective sample extraction channels 14A, 14B, 14C, 14E.

As an additional step, a quench fluid to extinguish a chemical reaction occurring in the sample may be supplied to the sample from the quench fluid supply 7. The quench fluid supply 7 is preferably connected to the sample extraction device 3A, 3B, 3C, 3D, 3E via the fluid supply channel 13, preferably downstream from the transportation fluid supply 10. This way, the transportation fluid can be used to transport the quench fluid to the sample space 5A, 5B, 5C, 5D, 5E. The quench fluid may be supplied to the sample before, during or after transport of the sample to the sample storage container 11A, 11B, 11C, 11D, 11E. The quench fluid may already be present in the sample storage container 11A, 11B, 11C, 11D, 11E before the sample is transported to the sample storage container 11A, 11B, 11C, 11D, 11E.

As an additional step, a dilution fluid to dilute the sample may be supplied to the sample from the dilution fluid supply 8. The dilution fluid supply 8 is preferably connected to the sample extraction device 3A, 3B, 3C, 3D, 3E via the fluid supply channel 13, preferably downstream from the transportation fluid supply 10. This way, the transportation fluid can be used to transport the dilution fluid to the sample. The dilution fluid may be supplied to the sample before, during or after transport of the sample to the sample storage container 11A, 11B, 11C, 11D, 11E. The dilution fluid may already be present in the sample storage container 11A, 11B, 11C, 11D, 11E before the sample is transported to the sample storage container 11A, 11B, 11C, 11D, 11E.

As an additional step, a rinsing fluid may be supplied to the fluid supply channel 13 and the sampling space 5A, 5B, 5C, 5D, 5E and the sample extraction channel 14A, 14B, 14C, 14D, 14E after storing the sample in the sample storage container 11A, 11B, 11C, 11D, 11E. The rinsing fluid is then deposited in a waste container 19. This ensures that no residue is left behind in the fluid supply channel 13 and the sampling space 5A, 5B, 5C, 5D, 5E and the sample extraction channel 14A, 14B, 14C, 14D, 14E after taking a sample, such that a next sample is not contaminated by such residue.

Using the transportation fluid to transport the quench fluid, the dilution fluid and/or the rinsing fluid through at least part of the fluid supply channel 13, the sampling space 5A, 5B, 5C, 5D, 5E and/or the sample extraction channel 14A, 14B, 14C, 14D, 14E provides an efficient way of transporting these fluids. In addition, the use of the transportation fluid to subsequently transport two fluids may create a separation between the two fluids. This prevents mixing of for example quench liquid and dilution fluid in the fluid supply channel 13, the sampling space 5A, 5B, 5C, 5D, 5E and/or the sample extraction channel 14A, 14B, 14C, 14D, 14E when transported subsequently through these channels. The use of transportation fluid for transport of the quench fluid, the dilution fluid and/or the rinsing fluid may be combined with fluid pumps, for example fluid pumps provided in the quench fluid supply 7, the dilution fluid supply 8 and the rinsing fluid supply 9.

Extraction of a sample from the reactor 2 into the sampling space 5 is performed by injecting the transportation fluid into the reactor volume 22 via the secondary fluid channel 26 while the sampling valve 25 is in the sampling position 29, thereby creating a pressure differential between the reactor volume 22 and the sampling space 5. This forces the fluid in the reactor volume 22 into the sample channel 21 via the sample channel entrance 23 and into the sampling space 5. The pressure in the reactor volume 22 as well as injection of transportation fluid into the reactor volume 22 is controlled via sampling control valves 321, 322, 323, 324. A first sampling control valve 321 and a second sampling control valve 322 are connected to the secondary fluid channel 26 via a secondary fluid valve 31. A third sampling control valve 323 and a fourth sampling control valve 324 are connected to the sample channel 21 via the sampling valve 25.

After the sample is extracted from the reactor 2 into the sampling space 5, the sampling valve 25 is arranged in the transportation position 30. A sample comprising a sample volume of reaction liquid from the reactor 2 is then present in the sampling space 5, the sample volume being equal to the cavity volume of the sampling space 5. The sample is subsequently transported from the sampling space 5 through the sample extraction 20 outlet into the sample extraction channel and from there into the sample storage container 11 or any other suitable destination.

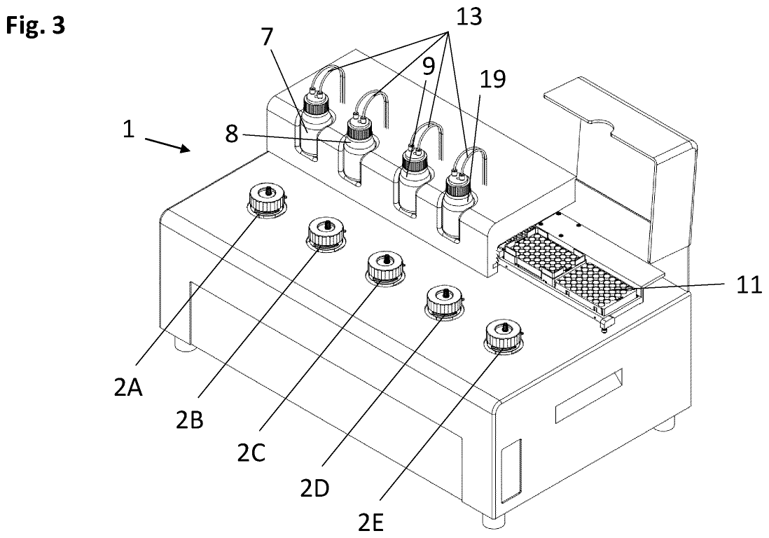

FIG. 3 shows a laboratory system 1 according to the invention. Multiple sample storage containers 11 are provided for each reactor 2A, 2B, 2C, 2D, 2E, such that multiple samples may be taken from each reactor 2A, 2B, 2C, 2D, 2E.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language, not excluding other elements or steps). Any reference signs in the claims should not be construed as limiting the scope of the claims or the invention.

The mere fact that certain measures are recited in mutually different dependent claims does not indicate that a combination of these measures cannot be used to advantage.

1. A laboratory system comprising:
at least one reactor,
a sample extraction device for extracting a sample from the at least one reactor into a sampling space,
a fluid supply system comprising a transportation fluid supply,
at least one sample storage container,
at least one fluid supply channel connecting the sample extraction device to the fluid supply system, and
at least one sample extraction channel connecting the sample extraction device to the sample storage container,
wherein the fluid supply system is arranged to push the sample from the sampling space through the sample extraction channel to the at least one sample storage container using transportation fluid of the transportation fluid supply.

2. The laboratory system according to claim 1, comprising:
multiple sample storage containers,
a container selection system to associate the at least one sample extraction channel with one of the multiple sample storage containers.

3. The laboratory system according to claim 1,
comprising multiple reactors,
the sample extraction device cooperating with each of the multiple reactors via a downstream reactor selection system for extracting a sample from a selected reactor into the sampling space,
wherein the at least one fluid supply channel connects the fluid supply system to the sample extraction device, and
the at least one sample extraction channel connects the sample extraction device to the at least one sample storage container.

4. The laboratory system according to claim 3, comprising N reactors, wherein the downstream reactor selection system comprises a downstream N-way valve configured for bringing the sample extraction device in fluid communication with one of the N reactors.

5. The laboratory system according to claim 1,
comprising multiple reactors and multiple sample extraction devices,
each sample extraction device having a sampling space and each sample extraction device cooperating with one of the multiple reactors for extracting a sample from the at least one reactor into the respective sampling space,
wherein the at least one fluid supply channel connects the fluid supply system to each sample extraction device, and
wherein the at least one sample extraction channel connects each sample extraction device to the at least one sample storage container.

6. The laboratory system according to claim 5, comprising N reactors, the laboratory system comprising an upstream reactor selection system configured for bringing the sample extraction device of one of the N reactors in fluid communication with the fluid supply system.

7. The laboratory system according to claim 6, wherein the upstream reactor selection system comprises an upstream N-way valve arranged in the fluid supply channel.

8. The laboratory system according to claim 1, wherein the at least one reactor is a thermal cycle reactor.

9. The laboratory system according to claim 1, wherein the fluid supply system comprises a quench fluid supply.

10. The laboratory system according to claim 9, wherein the fluid supply system is arranged to push quench fluid from the quench fluid supply through the fluid supply channel, the sampling space and/or the sample extraction channel using transportation fluid of the transportation fluid supply.

11. The laboratory system according to claim 1, wherein the fluid supply system comprises a dilution fluid supply.

12. The laboratory system according to claim 11, wherein the fluid supply system is arranged to push dilution fluid from the dilution fluid supply through the fluid supply channel, the sampling space and/or the sample extraction channel using transportation fluid of the transportation fluid supply.

13. The laboratory system according to claim 1, wherein the fluid supply system comprises a rinsing fluid supply.

14. The laboratory system according to claim 13, wherein the fluid supply system is arranged to push rinsing fluid from the rinsing fluid supply through the fluid supply channel, the sampling space and/or the sample extraction channel using transportation fluid of the transportation fluid supply.

15. The laboratory system according to claim 1, the sample extraction device comprising:
a sample channel configured to extend into a reactor volume of the reactor, the sample channel comprising a sample channel entrance configured to be arranged below a liquid level of a reaction liquid in the reactor volume of the reactor,
a sampling valve arranged in the sample channel and comprising the sampling space, wherein the sampling valve is movable between a sampling position and a transportation position,
a secondary fluid channel configured to extend into a reactor volume of the reactor, the secondary fluid channel comprising a secondary fluid channel entrance,
wherein, in the sampling position of the sampling valve, the sampling space is in fluid communication with the sample channel and wherein, in the transportation position of the sampling valve, the sampling space is in fluid communication with the at least one fluid supply channel and the at least one sample extraction channel.

16. The laboratory system according to claim 15, wherein the secondary fluid channel is connectable to the transportation fluid supply.

17. A method of sampling using a laboratory system according to any of the preceding claims, the method comprising the steps of:
extracting a sample from the reactor into the sampling space, and
transporting the sample to the sample storage container via the sample extraction channel by supplying the transportation fluid to the sampling space via the fluid supply channel.

18. The method according to claim 17, comprising the step of supplying a quench fluid from the quench fluid supply to the sample.

19. The method according to claim 18, wherein the quench fluid is supplied to the sample via the fluid supply channel.

20. The method according to claim 18, wherein the quench fluid is supplied to the sample in the sample storage container.

21. The method according to claim 18, wherein the step of supplying the quench fluid comprises pushing the quench fluid through the fluid supply channel, the sampling space and/or the sample extraction channel using transportation fluid of the transportation fluid supply.

22. The method according to claim 17, comprising the step of supplying a dilution fluid to the sample.

23. The method according to claim 22, wherein the dilution fluid is supplied to the sample via the fluid supply channel.

24. The method according to claim 22, wherein the dilution fluid is supplied to the sample in the sample storage container.

25. The method according to claim 22, wherein the step of supplying the dilution fluid comprises pushing the dilution fluid through the fluid supply channel, the sampling space and/or the sample extraction channel using transportation fluid of the transportation fluid supply.

26. The method according to claim 17, comprising a rinsing step of rinsing the fluid supply channel by supplying a rinsing fluid from a rinsing fluid supply to the fluid supply channel and depositing the rinsing fluid in a waste container.

27. The method according to claim 26, wherein the rinsing step further comprises rinsing the sampling space and/or the at least one sample extraction channel by supplying the rinsing fluid to the sampling space and/or the at least one sample extraction channel from the fluid supply channel.

28. The method according to claim 26, wherein the step of supplying the rinsing fluid comprises pushing the rinsing fluid through the fluid supply channel, the sampling space and/or the sample extraction channel using transportation fluid of the transportation fluid supply.

29. The method according to claim 17, wherein the sample is extracted from the reactor into the sampling space by injecting the transportation fluid into the reactor volume via the secondary fluid channel.

30. The method according to claim 17, comprising the step of registering a sample trigger to initiate sampling.

31. A sample extraction device configured for extracting a sample from a reactor, the sample extraction device comprising:
a sample extraction outlet,
a sample channel configured to extend into a reactor volume of the reactor, the sample channel comprising a sample channel entrance configured to be arranged below a liquid level of a reaction liquid in the reactor volume of the reactor,
a sampling valve arranged in the sample channel, and
a secondary fluid channel configured to extend into a reactor volume of the reactor, the secondary fluid channel comprising a secondary fluid channel entrance,
wherein: the sampling valve comprises a sampling space with a cavity volume,
wherein the sampling valve is movable between a sampling position and a transportation position, and
wherein the sampling space is in fluid communication with the sample channel in the sampling position of the sampling valve and wherein the sampling space is in fluid communication with the sample extraction outlet in the transportation position of the sampling valve.

32. A method of sampling a reaction liquid from a reactor using a sample extraction device according to claim 31, the method comprising the steps of:
arranging the sampling valve in the sampling position,
filling the sampling space with a sampling volume of reaction liquid via the sample channel, the sampling volume being equal to the cavity volume,
subsequently arranging the sampling valve in the transportation position, and
transporting the sampling volume of reaction liquid from the sampling space through the sample extraction outlet to a suitable destination.

33. The method according to claim 32, wherein the step of filling the sampling space is performed by applying a pressure differential between the reactor volume and the sampling space.

34. The method according to claim 33, wherein the pressure differential is achieved by introducing fluid into the reactor volume via the secondary fluid channel at a pressure above the pressure in the sampling space, thereby forcing the reaction liquid into the sampling space through the sample channel.
